(19) United States
(12) Patent Application Publication
(10) Pub. No.: US 2023/0415458 A1
(43) Pub. Date: Dec. 28, 2023

(54) COMPOSITE PANE COMPRISING A SUN SHADING COATING

(71) Applicant: SAINT-GOBAIN GLASS FRANCE, COURBEVOIE (FR)

(72) Inventors: Svenja BOURONE, AACHEN (DE); Alexandra TOUMAR, PARIS (FR)

(21) Appl. No.: 18/248,827

(22) PCT Filed: Nov. 23, 2021
(86) PCT No.: PCT/EP2021/082665

§ 371 Date: Apr. 12, 2023

(30) Foreign Application Priority Data
Nov. 27, 2020 (EP) 20210321.4

(51) Int. Cl. B32B 17/10; C03C 17/36

(52) U.S. Cl. CPC B32B 17/10229; B32B 17/10036; B32B 17/10201; B32B 17/10385; B32B 17/10807; B32B 17/10651; B32B 17/1011; C03C 17/3613; C03C 17/3639; C03C 17/3644; C03C 17/3626; C03C 17/366; C03C 17/3681; B32B 2605/00

(57) ABSTRACT

A composite pane includes an outer pane having an exterior-side surface and an interior-side surface, an inner pane having an exterior-side surface and an interior-side surface, and a thermoplastic intermediate layer, which joins the interior-side surface of the outer pane to the exterior-side surface of the inner pane. The composite pane has a sun shading coating between the outer and inner panes. The sun shading coating includes, starting from the inner pane toward the outer pane, a layer sequence first dielectric module, first silver layer Ag1, second dielectric module, second silver layer Ag2, third dielectric module, third silver layer Ag3, fourth dielectric module, wherein the silver layers have, relative to one another, a geometrical layer thickness of Ag2>Ag1>Ag3, and the silver layers of the sun shading coating have a relative geometrical layer thickness of 1.0<Ag1/Ag3 and 1.2<Ag2/Ag3<2.

The invention relates to a composite pane having an improved sun shading coating and use thereof.

Composite panes with electrically conductive coatings are well-known in the vehicle sector, for example, as a windshield with a heatable transparent coating. The coating typically comprises multiple silver layers that are applied alternatingly with dielectric layers, ensuring, on the one hand, high electrical conductivity and, on the other, sufficient transmittance in the visible spectral range. Also known are more complex electrically conductive coatings for windshields, which can, for example, be used as IR-reflective coatings to reduce the heating of the vehicle interior and thus improve thermal comfort. The coatings can, however, also be used as heatable coatings by connecting them to a voltage source such that a current flows through the coating. Suitable coatings include conductive metallic layers, in particular, based on silver. Since these layers are susceptible to corrosion, it is customary to apply them on the surface of the outer pane or the inner pane facing the intermediate layer such that they have no contact with the atmosphere. Silver-containing transparent coatings are known, for example, from WO03/024155, US2007/0082219A1, US2007/0020465A1, WO2013/104438 or WO2013/104439.

In particular, in the automotive sector, sun shading coatings are sought that are not only heatable, but also have low total solar transmittance (TTS), low external reflection, and neutral or blue reflection colors. In particular, yellow, red, and violet reflection colors are considered disturbing and should be avoided. Good sun shading properties of vehicle glazings also contribute to reducing the energy consumption of the air conditioning system and are thus also desirable from an environmental standpoint. In electric cars, reduced energy consumption of secondary systems such as air conditioning and heating means an increase in range. In electric vehicles, DC/DC converters are commonly used to increase the on-board voltage from 14 V to a supply voltage of 42 V, with which the heatable windshield is operated. Heatable sun shading coatings that have been designed for use in motor vehicles with internal combustion engines are generally designed for a supply voltage of 14 V and are not compatible with the operating range of the 14 V/42 V DC/DC converter. In this respect, to achieve reduced total solar transmittance (TTS), it is not expedient to merely increase the layer thicknesses of known heatable sun shading coatings that are designed for use of a 14 V supply voltage. Low total solar transmittance (TTS) is generally associated with high external reflectance of the coating; however, in practice the lowest possible value of both is desirable. In addition, windshields must comply with the legal specifications in accordance with the process for testing the light permeability of motor vehicle windows set forth in ECE-R 43, Annex 3, § 9.1, according to which the total transmittance T_{L} must be at least 70%. This makes low total solar transmittance more difficult. If a sun shading coating is to be used as a heatable coating in the automotive sector, have a visually appealing reflection color, and, at the same time, be compatible with the DC/DC converters commonly used in electric cars, high demands are made on its optical and electrical properties.

WO2019/206493A1 discloses a composite pane for a head-up display, at least one electrically conductive coating on one of the surfaces of the outer pane or the inner pane of the composite pane facing the thermoplastic intermediate layer, and an antireflection coating on the surface of the inner pane facing away from the thermoplastic intermediate layer. The electrically conductive coating comprises at least four electrically conductive silver layers with a total thickness of at least 60 nm, with, in each case, the dielectric layers being arranged between the silver layers. Viewed from the inner pane toward the outer pane, the third silver layer following the inner pane is the silver layer with the greatest thickness.

WO2020/094422 A1 relates to a projection assembly for a head-up display (HUD), at least comprising a composite pane with an HUD region, an electrically conductive coating on the surface of the outer pane or the inner pane facing the thermoplastic intermediate layer, and a projector. The electrically conductive coating comprises at least four electrically conductive layers that are arranged in each case between two dielectric layers, with the sum of the thicknesses of all electrically conductive layers being at most 30 nm and with at least one of the electrically conductive layers having a thickness of at most 5 nm.

WO 2020/094423A1 describes a projection arrangement for a head-up display (HUD), that comprises a composite pane with an electrically conductive coating and a projector, wherein the electrically conductive coating includes at least three electrically conductive layers, wherein the sum of the thicknesses of all the electrically conductive layers is at most 30 nm and wherein the electrically conductive layers have a thickness of 5 nm to 10 nm.

The object of the present invention consists in providing a further improved composite pane having a sun shading function, wherein the electrical, energy, and optical properties of the composite pane should be further improved.

This object is accomplished according to the invention by a composite pane according to the independent claim 1. Advantageous embodiments of the invention are apparent from the subclaims.

The composite pane according to the invention comprises an outer pane having an exterior-side surface (side I) and an interior-side surface (side II), an inner pane having an outer surface (side III) and an interior-side surface (side IV), and a thermoplastic intermediate layer that joins the interior-side surface of the outer pane to the exterior-side surface of the inner pane, wherein the composite pane has, between the outer pane and the inner pane, at least one sun shading coating that substantially reflects or absorbs rays outside the visible spectrum of solar radiation, in particular infrared radiation, wherein the sun shading coating includes, from the direction of the inner pane toward the outer pane, a layer sequence
first dielectric module (M1),
first silver layer (Ag1),
second dielectric module (M2),
second silver layer (Ag2),
third dielectric module (M3),
third silver layer (Ag3),
fourth dielectric module (M4).

The silver layers (Ag1, Ag2, Ag3) of the sun shading coating according to the invention have, relative to one another, a layer thickness of Ag2>Ag1>Ag3. Accordingly, the second silver layer Ag2 is the silver layer with the greatest thickness, followed by the first silver layer Ag1, whose thickness is between the thickness of the second silver layer and the thickness of the third silver layer, and the third silver layer Ag3 as the silver layer with the smallest layer thickness. The first silver layer Ag1 and the third silver layer Ag3 have a layer thickness of 1.0<Ag1/Ag3 relative to one another, while the second silver layer Ag2 and the third silver layer have a layer thickness of 1.2<Ag2/Ag3<2 relative to one another. This has proved to be particularly advantageous in terms of further improved optical and electrical properties of the composite pane, in particular in terms of a visually appealing blue reflection color of the coating at different reflection angles.

The structure of the layer sequence of the sun shading coating according to the invention is considered starting from the direction of the inner pane. This means that the fourth dielectric module is the layer of the sun shading coating nearest the interior-side surface (side II) of the outer pane and the first dielectric module is the layer of the sun shading coating nearest the exterior-side surface (side III) of the inner pane. Following the first dielectric module (M1) nearest the exterior-side surface (side III) of the inner pane, in this order, starting from the inner pane toward the outer pane, are the first silver layer (Ag1), the second dielectric module (M2), the second silver layer (Ag2), the third dielectric module (M3), the third silver layer (Ag3), and the fourth dielectric module (M4). The fourth dielectric module is thus the layer of the sun shading coating farthest from the exterior-side surface (side III) of the inner pane and nearest the interior-side surface (side II) of the outer pane. The silver layers are in each case arranged between dielectric modules, i.e., dielectric layers or layer sequences. The sun shading coating is arranged between the interior-side surface (side II) of the outer pane and the exterior-side surface (side III) of the inner pane and can, for example, be applied to one of the surfaces of the pane or integrated into the thermoplastic intermediate layer.

In other words, provision is made according to the invention for the layer thickness of the second silver layer (Ag2) of the sun shading coating to be greater than the respective layer thickness of the two other silver layers Ag1 and Ag3 positioned below and above it. The first silver layer Ag1 is arranged below the second silver layer Ag2 in the layer sequence of the sun shading coating and thus farther from the outer pane, while the third silver layer Ag3 is arranged above the second silver layer Ag2 in the layer sequence and thus nearer the outer pane. Furthermore, the thickness of the first silver layer Ag1 is greater than the thickness of the third silver layer Ag3.

Surprisingly, it is been shown that a composite glass pane according to the invention has, compared to the previously known composite glass panes with sun shading coating, significantly improved electrical, optical, and aesthetic properties and, at the same time, good energy properties; in particular, undesirable color tones in the reflection of the composite pane can be minimized or even avoided. Furthermore, an at most very slight angle-dependent change in the reflection color is achieved. Moreover, the composite pane according to the invention is compatible with a 14V/42V DC/DC converter and can, if need be, be heated with a supply voltage of 42 V.

The composite pane comprises an outer pane and an inner pane, joined to one another via a thermoplastic intermediate layer. The composite pane is intended, in a window opening, in particular the window opening of a vehicle, to separate the interior from the external surroundings. In the context of the invention, “inner pane” refers to the pane of the composite pane facing the interior (in particular, the vehicle interior). “Outer pane” refers to the pane facing the external surroundings.

The composite pane has an upper edge and a lower edge as well as two side edges extending therebetween. The term “upper edge” refers to that edge which is intended, in the installed position, to point upward. The term “lower edge” refers to that edge which is intended, in the installed position, to point downward. In the case of a windshield, the upper edge is often also referred to as the “roof edge” and the lower edge as the “engine edge”.

The outer pane and the inner pane have, in each case, an exterior-side and an interior-side surface and a circumferential side edge running therebetween. In the context of the invention, “exterior-side surface” refers to that primary surface intended to face the external surroundings in the installed position. In the context of the invention, “interior-side surface” refers to that primary surface intended to face the interior in the installed position. The interior-side surface of the outer pane and the exterior-side surface of the inner pane face each other and are joined to one another by the thermoplastic intermediate layer.

The sun shading coating of the composite pane according to the invention is preferably applied to one of the surfaces of the two panes facing the intermediate layer, i.e., the interior-side surface of the outer pane or the exterior-side surface of the inner pane. Alternatively, the sun shading coating can also be arranged within the thermoplastic intermediate layer, for example, on a carrier film that is arranged between two thermoplastic bonding films. The sun shading coating is further suitable as an IR-reflecting coating. In particular, the coating is applied over the entire surface of the pane with the exception of a circumferential edge region and optional local region which, as communication, sensor, or camera windows, are intended to ensure transmission of electromagnetic radiation through the composite pane and, consequently, are not provided with the coating. The circumferential uncoated edge region has, for example, a width of up to 20 cm. It prevents direct contact of the coating with the surrounding atmosphere such that the coating is protected, in the interior of the composite pane, against corrosion and damage.

In a preferred embodiment, the composite pane is a windshield and the sun shading coating is implemented as a transparent coating. Considered as a “transparent coating” is a coating that has an average transmittance in the visible spectral range of at least 70%, preferably at least 72.5%, i.e., does not significantly restrict vision through the pane. Transmittance in the visible range of light of at least 72.5% is advantageous, in particular, when additional components of the pane restrict transmittance. The coating is suitable to be heated with a supply voltage of preferably 42 V, but can also be used as a pure sun shading coating without corresponding electrical connections for heating. At the request of the customer, other means for heating, for example, additional heating wires, can be provided in such a composite pane whose sun shading coating has no electrical connections for contacting a voltage source. These further limit the transmittance through the pane such that the coating used must have transmittance of at least 72.5%. Astonishingly, this criterion is met by the composite pane according to the invention despite the many restrictions imposed by optical, energy, and electrical requirements.

Preferably, at least 80% of the pane surface is provided with the coating according to the invention.

If a first layer is arranged above a second layer, this means, in the context of the invention, that the first layer is arranged farther in the direction of the outer pane than the second layer. If a first layer is arranged below a second layer, this means, in the context of the invention, that the second layer is arranged farther in the direction of the inner pane than the first layer.

If a layer is based on a material, the layer consists for the most part of this material, in particular essentially of this material, in addition to any impurities or dopants.

The sun shading coating is a layer stack or a layer sequence, in particular composed of thin layers, comprising multiple silver layers, with each silver layer arranged, in each case, between two dielectric layers or layer sequences. These dielectric layers or layer sequences are referred to as dielectric modules. The term “a dielectric module” thus means a dielectric layer which can be formed from a single ply, i.e., a single dielectric layer, or from multiple plies of dielectric layers. The coating is thus a thin layer stack with n silver layers and (n+1) dielectric layers or layer sequences, where n is a natural number and where a silver layer and a dielectric layer or layer sequence alternatingly follow a lower dielectric layer or layer sequence.

The sun shading coating is a thin layer stack, i.e., a layer sequence of thin individual layers, and preferably comprises at least four dielectric modules (M1, M2, M3, and M4), i.e., at least four dielectric layers. Each functional silver layer is arranged between two dielectric layers or layer sequences. The functional layers or layer sequences and the dielectric layers are arranged such that at least one dielectric layer is arranged in each case between two adjacent functional silver layers, between which no other functional silver layer is arranged, and that at least one other dielectric layer is arranged above the uppermost functional layer; and that at least one other dielectric layer is arranged below the lowest functional layer.

The sun shading coating according to the invention has at least three silver layers. Said natural number n is thus at least 3. The coating comprises at least the following layers or layer sequences, which are arranged in the order indicated starting from the inner pane to the outer pane:
a first dielectric layer or layer sequence as module M1,
a first silver layer Ag1,
a second dielectric layer or layer sequence as module M2,
a second silver layer Ag2,
a third dielectric layer or layer sequence as module M3,
a third silver layer Ag3, and
a fourth dielectric layer or layer sequence as module M4.

The coating according to the invention can include further silver layers and dielectric modules, which are arranged above the fourth dielectric module M4 (n>3). In a particularly preferred embodiment, said natural number n is, however, exactly 3. Accordingly, the sun shading coating preferably includes exactly three silver layers, i.e., not less than three and also not more than three silver layers. More complex layer structures are, in principle, not necessary to achieve the required specifications of the coatings. More complex layer structures are also more complicated to deposit. In this regard, it is a major advantage of the invention to achieve the desired properties of the coating with only three silver layers. In addition to the silver layers, however, other metal-containing layers can be present, which do not contribute significantly to the sun shading properties of the coating, but serve a different purpose. This is true in particular for metallic blocking layers with geometrical thicknesses of less than 1 nm, which are preferably arranged between the silver layer and the dielectric modules.

The silver layers give the sun shading coating the basic IR-reflecting effect and the electrical conductivity necessary for heating the pane. In this context, the term “silver layer” designates a layer formed on the basis of silver. The silver layers are based on silver. The silver layers preferably contain at least 90 wt.-% silver, particularly preferably at least 99 wt.-% silver, most particularly preferably at least 99.9 wt.-% silver. The silver layers can have dopants, for example, palladium, gold, copper, or aluminum.

The first dielectric module M1, the second dielectric module M2, the third dielectric module M3, and the fourth dielectric module M4 preferably have an optical layer thickness relative to one another of M2/M1≥1.9, M2/M3≥0.8, and M2/M4≥2. A composite pane with this configuration of the sun shading coating shows further improved optical and aesthetic properties and higher transmittance T_{L} in the visible range of light.

In one embodiment of the invention, all dielectric layers have a refractive index greater than 1.8, preferably greater than 1.9. In other words, all dielectric layers or layer sequences of the dielectric modules are formed exclusively by dielectric layers with a refractive index greater than 1.8. Thus, good results are obtained. The dielectric layers can, for example, be based on silicon nitride, mixed silicon-metal nitrides (such as silicon-zirconium nitride (SiZrN), mixed silicon-aluminum nitride, mixed silicon-hafnium nitride, or mixed silicon-titanium nitride), aluminum nitride (AlN), tin oxide (SnO), manganese oxide (MnO), tungsten oxide (WO₃), niobium oxide (Nb₂O₅), bismuth oxide (Bi₂O₃), titanium dioxide (TiO₂), zinc oxide (ZnO), or mixed tin-zinc oxide (SnZnO).

In the context of the present invention, refractive indices are, in principle, indicated in relation to a wavelength of 550 nm. The optical thickness is the product of the geometrical thickness and the refractive index (at 550 nm). The optical thickness of a layer sequence is calculated as the sum of the optical thicknesses of the individual layers. The refractive index can, for example, be determined by ellipsometery. Ellipsometers are commercially available, for example, from the company Sentech. The refractive index of a dielectric layer is preferably determined by first depositing it on a substrate as a single layer and then measuring the refractive index by ellipsometery. To determine the refractive index of a dielectric layer sequence, the layers of the layer sequence are in each case deposited alone as single layers on a substrate, and then the refractive index is determined by ellipsometery. In a preferred embodiment, a refractive index of at least 1.8 must be achieved for each of these individual layers. Dielectric layers with a refractive index of at least 1.8 as well as methods for their deposition are known to the person skilled in the art in the field of thin films. Preferably, methods of physical vapor deposition, in particular magnetron sputtering, are used.

The materials mentioned in the present description can be deposited stoichiometrically, substoichiometrically, or superstoichiometrically. The materials can have dopants, in particular aluminum, boron, zirconium, or titanium. By means of the dopants, inherently dielectric materials can be provided with a certain electrical conductivity. The person skilled in the art will nevertheless identify them in terms of their function as dielectric layers, as is customary in the field of thin layers. The material of the dielectric layers preferably has electrical conductivity (reciprocal of the specific resistance) of less than 10⁻⁴ S/m. The material of the silver layers preferably has electrical conductivity greater than 10⁻⁴ S/m.

Preferably, the first dielectric module, the second dielectric module, the third dielectric module, and/or the fourth dielectric module include a dielectric layer acting as an antireflection layer. In an advantageous embodiment, each dielectric module includes a dielectric layer as an antireflection layer. The antireflection layers reduce the reflection of visible light and thus increase the transparency of the coated pane. The antireflection layers are, for example, based on silicon nitride (Si₃N₄), mixed silicon-metal nitrides such as silicon-zirconium nitride (SiZrN), aluminum nitride (AlN), or tin oxide (SnO). In addition, the antireflection layers can have dopants. The antireflection layers preferably have geometrical thicknesses of 5 nm to 100 nm, particularly preferably of 6 nm to 60 nm. Silicon nitrides are particularly preferred as antireflection layers, since they have a higher refractive index, compared to the oxides, as a result of which a comparatively lower silicon nitride layer thickness is required. Furthermore, good color properties of the coating are achieved.

In an advantageous embodiment, one or more dielectric modules has/have a first matching layer, preferably at least each dielectric module that is arranged below a silver layer. The first matching layer is preferably arranged above the antireflection layer. The first matching layer is preferably arranged directly below the first silver layer such that it makes direct contact with the respective silver layer. This is particularly advantageous with regard to the crystallinity of the silver layer. In an advantageous embodiment, one or more dielectric modules, preferably each dielectric module, has/have a second matching layer that is arranged above a silver layer. The second matching layer is preferably arranged below the antireflection layer.

The first matching layer and/or the second matching layer preferably contains zinc oxide ZnO. The first matching layer and/or the second matching layer also preferably contains dopants. The first matching layer and/or the second matching layer can contain, for example, aluminum-doped zinc oxide (ZnO:Al). The zinc oxide is preferably deposited substoichiometrically with respect to oxygen in order to avoid a reaction of excess oxygen with the silver-containing layer. The geometrical layer thicknesses of the first matching layer and the second matching layer are preferably from 5 nm to 20 nm, particularly preferably from 8 nm to 20 nm. Zinc oxide has, due to its good smoothing properties, proved to be a preferred material for the matching layers, by which means advantageously high conductivity of the adjacent silver layer can be achieved.

In an advantageous embodiment, one or more dielectric modules has/have at least one dielectric layer as a smoothing layer, preferably each dielectric module that is arranged between two silver layers, particularly preferably also the lowest first dielectric module. The at least one smoothing layer is arranged below the first matching layers, preferably between the antireflection layer and the first matching layer, if there is such a first matching layer. The smoothing layer is particularly preferably in direct contact with the first matching layer. The smoothing layer has the effect of optimizing, in particular smoothing, the surface for a silver layer subsequently applied above. A silver layer deposited on a smoother surface has higher transmittance with, at the same time, lower sheet resistance. The geometrical layer thickness of a smoothing layer is preferably from 5 nm to 20 nm, particularly preferably from 7 nm to 12 nm. The smoothing layer preferably has a refractive index of less than 2.2.

The smoothing layer contains at least one non-crystalline oxide. The oxide can be amorphous or partially amorphous (and thus partially crystalline), but is not fully crystalline. The non-crystalline smoothing layer has low roughness and thus forms an advantageously smooth surface for the layers to be applied above the smoothing layer. The non-crystalline smoothing layer further brings about an improved surface structure of the layer deposited directly above the smoothing layer, which is preferably the first matching layer. The smoothing layer can, for example, contain at least one oxide of one or more of the elements tin, silicon, titanium, zirconium, hafnium, zinc, gallium, and indium. The smoothing layer preferably contains a noncrystalline mixed oxide. Most particularly preferably, the smoothing layer contain a mixed tin-zinc oxide (ZnSnO). The mixed oxide can have dopants. The smoothing layer can, for example, contain an antimony-doped mixed tin-zinc oxide. The mixed oxide preferably has a substoichiometric oxygen content. The tin content is preferably between 10 and 40 wt.-%, particularly preferably between 12 and 35 wt.-%.

In an advantageous embodiment, the sun shading coating includes one or more blocking layers. Preferably, at least one blocking layer is associated with at least one, particularly preferably with each silver layer. The blocking layer is in direct contact with the silver layer and is arranged immediately above or immediately below the silver layer. I.e., no other layer is arranged between the silver layer and the associated blocking layer. A blocking layer can, in each case, also be arranged immediately above and immediately below a silver layer. The blocking layer preferably contains niobium, titanium, nickel, chromium, and/or alloys thereof, particularly preferably nickel-chromium alloys. The geometrical layer thickness of the blocking layer is preferably from 0.1 nm to 1.5 nm, particularly preferably from 0.1 nm to 1.0 nm. A blocking layer immediately below a silver layer serves in particular to stabilize the silver layer during a temperature treatment and improves the optical quality of the sun shading coating. A blocking layer immediately above a silver layer prevents contact of the sensitive silver layer with the oxidizing reactive atmosphere during the deposition of the following layer by reactive cathodic sputtering, for example, of the second matching layer.

If a layer is based on a material, the layer consists for the most part of this material, in addition to any impurities or dopants. If a first layer is arranged above a second layer, this means, in the context of the invention, that the first layer is arranged farther from the substrate on which the coating is applied than the second layer. If a first layer is arranged below a second layer, this means, in the context of the invention, that the second layer is arranged farther from the substrate than the first layer. If a first layer is arranged above or below a second layer, this does not necessarily mean, in the context of the invention, that the first and the second layer are situated in direct contact with one another. One or more other layers can be arranged between the first and second layer, unless this is explicitly ruled out.

In an advantageous embodiment, in each case, between two adjacent silver layers, a dielectric module comprising the following dielectric layer sequence is arranged:
an antireflection layer based on silicon nitride, mixed silicon-metal nitrides such as silicon-zirconium nitride, aluminum nitride, and/or tin oxide,
a smoothing layer based on an oxide of one or more of the elements tin, silicon, titanium, zirconium, hafnium, zinc, gallium, and indium,
a first and a second matching layer based on zinc oxide, and
optionally, a blocking layer based on niobium, titanium, nickel, chromium, and/or alloys thereof. A specific order of the layers is not required. An antireflection layer and a matching layer based on the above-mentioned preferred materials are preferably arranged below the lowest silver layer and above the uppermost silver layer. In a preferred embodiment including three silver layers, the lowest silver layer is the first silver layer and the uppermost silver layer is the third silver layer.

The dielectric modules preferably have, in each case, a geometrical thickness from 10 nm to 100 nm, particularly preferably from 20 nm to 90 nm, for example, between 70 nm and 85 nm. The optical thickness of the modules is obtained by multiplying the geometrical thickness of the dielectric modules by the refractive index of the respective layers. The optical thickness of the dielectric modules is between 20 nm and 240 nm, preferably between 40 nm and 200 nm.

The geometrical thickness of each functional silver layer of the sun shading coating is preferably from 5 nm to 25 nm. The geometrical total layer thickness of all functional silver layers of the sun shading coating is preferably from 20 nm to 75 nm, particularly preferably from 25 nm to 60 nm. In these ranges for the thickness of the functional layer and the total thickness of all functional silver layers, particularly good results are achieved in terms of the sun shading function and transparency.

The first silver layer (Ag1) preferably has a geometrical thickness of 7 nm to 14 nm, the second silver layer (Ag2) preferably has a geometrical thickness of 7 nm to 16 nm, and the third silver layer (Ag3) has a geometrical thickness of 6 nm to 13 nm. Layer thicknesses within these ranges have proved advantageous for achieving sheet resistances of the sun shading coating of 1.0 Ω/sq to 1.5 Ω/sq, which are particularly suitable for use of the coating with a supply voltage of 42 V.

The sun shading coating according to the invention has IR-reflecting properties such that it functions as a sun shading coating that reduces the heating of the vehicle interior by reflecting thermal radiation. The TTS value of the composite pane provided with the coating is preferably less than 50%, particularly preferably less than 45%. TTS value refers to the total solar energy transmitted, measured in accordance with ISO 13837—it is a measure of thermal comfort. The coating can also be used as a heating coating when it is electrically contacted such that a current flows through it, heating the coating.

The outer pane and the inner pane are preferably made of glass, in particular soda lime glass, which is common for window panes. However, the panes can, in principle, also be made of other types of glass (for example, borosilicate glass, quartz glass, aluminosilicate glass) or transparent plastics (for example, polymethyl methacrylate or polycarbonate). The thickness of the outer pane and the inner pane can vary widely. Preferably, panes with a thickness in the range from 0.8 mm to 5 mm, preferably from 1.4 mm to 2.9 mm, for example, those with the standard thicknesses 1.6 mm or 2.1 mm, are used.

The outer pane, the inner pane, and the thermoplastic intermediate layer can be clear and colorless, but also tinted or colored. The tinting of the outer pane, the inner pane, and the thermoplastic intermediate layer is selected as a function of the desired application of the composite pane. When the composite pane is used as a windshield, high transmittance in the visible range of the light spectrum is desired and dark tinting of the components is not used. In one embodiment as a windshield of a motor vehicle, the total transmittance through the composite glass is greater than 70%, based on illuminant A. The term “total transmittance” is based on the process for testing the light permeability of motor vehicle windows specified by ECE-R 43, Annex 3, § 9.1. The outer pane and the inner panes can, independently of one another, be non-prestressed, partially prestressed, or prestressed. If at least one of the panes is to be prestressed, this can be thermal or chemical prestressing.

Suitable glass panes include glass panes that are known under the tradenames Planiclear® and Planilux® (clear glass, in each case), VG 10, VG20, VG40 or TSANx, TSA3+, TSA4+ from Saint-Gobain, with the glasses from the VG series gray-colored glasses and those of the TSA series green-colored glasses.

In a preferred embodiment, the composite pane is intended as a windshield of a motor vehicle, wherein at least the thermoplastic intermediate layer, the inner pane, and the outer pane are clear.

The composite pane is preferably curved in one or a plurality of spatial directions, as is customary for motor vehicle panes, wherein typical radii of curvature are in the range from approx. 10 cm to approx. 40 m. The composite pane can, however, also be flat, for example, when it is intended as a pane for buses, trains, or tractors.

The interior-side surface of the outer pane and the exterior-side surface of the inner pane face one another and are bonded to one another by means of the thermoplastic intermediate layer. The thermoplastic intermediate layer is formed by one or more thermoplastic films, wherein in the resulting composite pane, it is possible that the individual films in the resulting intermediate layer can no longer be distinguished from one another. The thermoplastic films preferably contain polyvinyl butyral (PVB), ethylene vinyl acetate (EVA), polyurethane (PU), and/or mixtures thereof and/or copolymers thereof, particularly preferably polyvinyl butyral. The films are preferably based on the materials mentioned but can, however, contain other components, for example, plasticizers, colorants, IR or UV absorbers.

The thermoplastic intermediate layer contains at least one thermoplastic polymer, preferably ethylene vinyl acetate (EVA), polyvinyl butyral (PVB), or polyurethane (PU) or mixtures or copolymers or derivatives thereof, particularly preferably PVB. The thickness of the intermediate layer is preferably from 0.2 mm to 2 mm, particularly preferably from 0.3 mm to 1 mm. The individual polymer films of the intermediate layer, in particular the PVB films, preferably have a thickness of about 0.2 mm to 1 mm, for example, 0.38 mm, 0.76 mm, or 0.81 mm. Other properties of the composite glass pane can be influenced by the thickness of the films. For example, thicker PVB films provide improved sound damping, in particular when they contain an acoustically active core, increased break-in resistance of the composite glass pane, and also increased protection against ultraviolet radiation (UV protection).

According to the invention, the sun shading coating is arranged between the outer pane and the inner pane. In a preferred embodiment, the sun shading coating is applied on the interior-side surface of the outer pane (side II). In this way, the sun shading coating is protected, in the laminate of the composite pane, against weathering influences. Positioning the sun shading coating as far outward as possible, i.e., as close as possible to the outer face of the outer pane, is advantageous in terms of particularly good sun shading action. This is further optimized by using a clear, non-tinted outer pane.

In another possible embodiment, the sun shading coating is embedded in the thermoplastic intermediate layer. The sun shading coating can be applied on a thermoplastic film. In a preferred embodiment, the sun shading coating is applied on a carrier film that is arranged, in the production of the composite pane, for example, between two thermoplastic films that serve to form the intermediate layer. The integration of the sun shading coating via a carrier film is advantageous in terms of simple prefabrication and provision of the carrier film with sun shading coating. The film of the thermoplastic intermediate layer positioned between the sun shading coating and the outer pane is preferably clear and non-tinted. The thermoplastic intermediate layer of the composite pane contains a carrier film that has the sun shading coating above it, i.e., on the surface facing the outer pane. The carrier film preferably contains or is made of polyethylene terephthalate (PET) and has a thickness from 20 μm to 100 μm, for example, roughly 50 μm. However, the carrier film can also be made of other suitable plastics.

In another preferred embodiment, the sun shading coating is applied on the exterior-side surface III of the inner pane. In this case, the outer pane and the thermoplastic intermediate layer are preferably clear and non-tinted. This embodiment is advantageous depending on the position of the opaque masking print in the edge region and enables greater flexibility in terms of the printing inks used for the masking print.

When the sun shading coating is provided as a heating coating, it is electrically connected to an external voltage source in a manner known per se, with heating of the coating occurring through the application of a voltage. The electrical contacting is implemented via suitable connection cables, for example, foil conductors, which are preferably connected to the sun shading coating via so-called bus bars, for example, strips of an electrically conductive material or electrically conductive imprints.

Preferably, at least two bus bars are attached to the sun shading coating and electrically conductively connected thereto. These at least two bus bars are preferably attached along opposite edges of the composite pane and can be electrically conductively connected to opposite poles of a voltage source to heat the pane. The coating region between the bus bars is electrically heatable therewith. In a possible embodiment of the invention, three bus bars are applied, with one bus bar each running parallel to the horizontal edges and the third bus bar projecting from the roof edge toward the center of the pane. The first bus bar is situated adjacent the roof edge, while the second bus bar is adjacent the engine edge and both bus bars run parallel to these horizontal side edges. In a particularly preferred embodiment, the shape of one or more bus bars is adapted to any decoated regions for sensor windows that serve for attachment of sensors. The busbars have a thickness of 5 μm to 20 μm, preferably 8 μm to 15 μm. The width of the bus bars is 0.5 mm to 30 mm, preferably 1 mm to 20 mm.

In another preferred embodiment, the sun shading coating is not intended to be connected to a voltage source. Optionally, other means for heating the pane are provided, for example, in the form of heating wires that are attached between the exterior-side surface (side III) of the inner pane and the interior-side surface (side II) of the outer pane. The heating wires are preferably inserted in the thermoplastic intermediate layer. The heating wires can, optionally, be electrically insulated. This allows contact between the wires and the coating while avoiding short circuits. The bonding film of the thermoplastic intermediate layer provided with heating wires can thus be attached to the wires facing toward the coating. If the wires are not insulated, the heating wires should be positioned on the side of the bonding film facing away from the coating. Insulation of the wires is achieved, for example, by a polymer-containing sheath; particularly preferably, this contains polyethylene, polyvinyl chloride, polytetrafluoroethylene, polyesters, polycarbonates, rubber, silicone rubber, polyamide, polyurethane, and/or mixtures and/or copolymers thereof.

The minimum distance between adjacent heating wires is 2 mm, while the maximum distance between adjacent wires is 35 mm.

The heating wires contain tungsten, copper, nickel, manganese, aluminum, silver, chromium, and/or iron and/or mixtures and/or alloys thereof, preferably tungsten or copper, particularly preferably tungsten.

The heating wires have a thickness of 5 μm to 160 μm, with the thickness depending, among other things, on the material used for the wires. Tungsten wires are preferably used with a thickness of 10 μm to 80 μm, while copper wires preferably have a thickness of 60 μm to 150 μm.

The heating wires are contacted at their ends via a plurality of electrical conductors, preferably two electrical conductors. Depending on the course of the heating wires, for example, meandering or zigzag, a different form of contacting can be selected. In the case of a continuous meandering wire, a voltage has to be applied, for example, only selectively at the two ends of the wires.

Preferably, the composite glass pane has external energy reflection RE>30%. Calculation of the energy value RE is carried out in accordance with the standard ISO 9050.

An opaque masking layer, for example, in the form of a screen print is preferably applied in the edge region of the pane such that this screen print circumscribes the field of vision of the pane or forms its outer edge. Any bus bars and electrical conductors as well as an optionally provided coating-free edge region are preferably covered by this masking print and are thus visually concealed. The opaque screen print can be applied in any plane of the composite glass pane.

The invention further includes a method for producing a composite pane according to the invention having a sun shading coating, comprising the following steps.
a) Applying a sun shading coating on the interior-side surface II of the outer pane, or on the exterior-side surface III of the inner pane, or introducing the sun shading coating into the thermoplastic intermediate layer;
b) Producing a layer stack at least comprising, in the following order, the outer pane, the thermoplastic intermediate layer, and the inner pane, and
c) Joining the layer stack at least comprising the outer pane, the thermoplastic intermediate layer, and the inner pane to form the composite pane.

The outer pane and the inner pane are joined to form a composite glass preferably after the sun shading coating has been applied.

The sun shading coating can withstand high thermal loads such that it can also withstand temperature treatment or bending of the panes at temperatures typically exceeding 600° C. without damage.

The individual layers of the sun shading coating can be deposited by methods known per se, preferably by magnetron-enhanced cathodic sputtering and built up in the suitable layer thicknesses and layer sequences. The cathodic sputtering can be carried out in a protective gas atmosphere, for example, of argon, or in a reactive gas atmosphere, for example, by addition of oxygen or nitrogen. However, the individual layers can also be applied by other suitable methods known to the person skilled in the art, for example, vapor deposition or chemical vapor deposition.

The thermoplastic intermediate layer can be provided in the form of a thermoplastic film. However, the thermoplastic intermediate layer can also be provided in the form of multiple films, for example, two or more thermoplastic films, optionally, an additional carrier film. The application of the sun shading coating on the thermoplastic intermediate layer includes only the application of the sun shading coating on one of the films, for example, on the carrier film. During the joining of the pane to form the composite glass, the carrier film with a sun shading coating arranged thereon is preferably arranged between two thermoplastic films, with the surface of the sun shading coating facing the outer pane.

The electrical contacting of the electrically conductive layers via bus bars or other suitable electrical conductors is carried out prior to the lamination of the composite pane.

Any imprints that may be present, for example, opaque masking prints or printed bus bars for the electrical contacting of the sun shading coating are preferably applied by screen printing.

The joining of the outer pane and the inner pane via the thermoplastic intermediate layer to form the composite pane is preferably done by lamination under the action of heat, vacuum, and/or pressure. Methods known per se for producing a composite pane can be used. During lamination, the heated, flowable thermoplastic material flows around the sun shading coating such that a stable bond is established and the sun shading coating is encapsulated in the intermediate layer and protected against damage and environmental influences.

For example, so-called autoclave methods can be carried out at an elevated pressure of approx. 10 bar to 15 bar and temperatures of 130° C. to 145° C. for about 2 hours. Vacuum bag or vacuum ring methods known per se operate, for example, at about 200 mbar and 80° C. to 110° C. The outer pane, the thermoplastic intermediate layer, and the inner pane can also be pressed in a calender between at least one roller pair to form a pane.

Systems of this type are known for producing panes and usually have at least one heating tunnel upstream from a pressing unit. The temperature during the pressing operation ranges, for example, from 40° C. to 150° C. Combinations of calendering and autoclaving methods have proved particularly effective in practice. Alternatively, vacuum laminators can be used. These consist of one or more heatable and evacuable chambers in which the panes are laminated within, for example, about 60 minutes at reduced pressures of 0.01 mbar to 800 mbar and temperatures from 80° C. to 170° C.

The invention further includes the use of the composite pane according to the invention having a sun shading coating in means of locomotion for travel on land, in the air, or on water, in particular in motor vehicles, for example, as a windshield, rear window, side window, and/or roof panel, and as a functional individual piece, and in buildings.

All standards mentioned refer to the version valid on the filing date.

The various embodiments of the invention can be implemented individually or in any combinations. In particular, the features mentioned above and to be explained in the following can be used not only in the combinations indicated, but also in other combinations or in isolation, without departing from the scope of the invention, unless exemplary embodiments and/or their features are explicitly mentioned only as alternatives or are mutually exclusive.

In the following, the invention is presented in more detail with reference to the figures. It should be noted that different aspects are described, each of which can be used individually or in combination. In other words, any aspects can be used with different embodiments of the invention unless explicitly presented as a pure alternative.

The drawings are simplified schematic representations and are not to scale. The drawings in no way restrict the invention.

They depict:

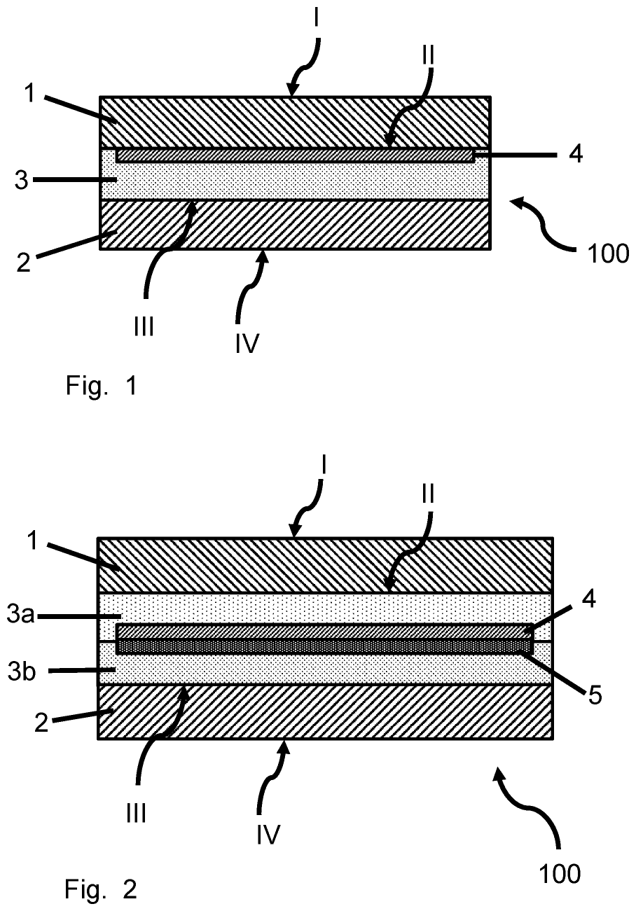

FIG. 1 a cross-section through a first embodiment of the composite pane according to the invention having a sun shading coating,

FIG. 2 a cross-section through another embodiment of the composite pane according to the invention having a sun shading coating,

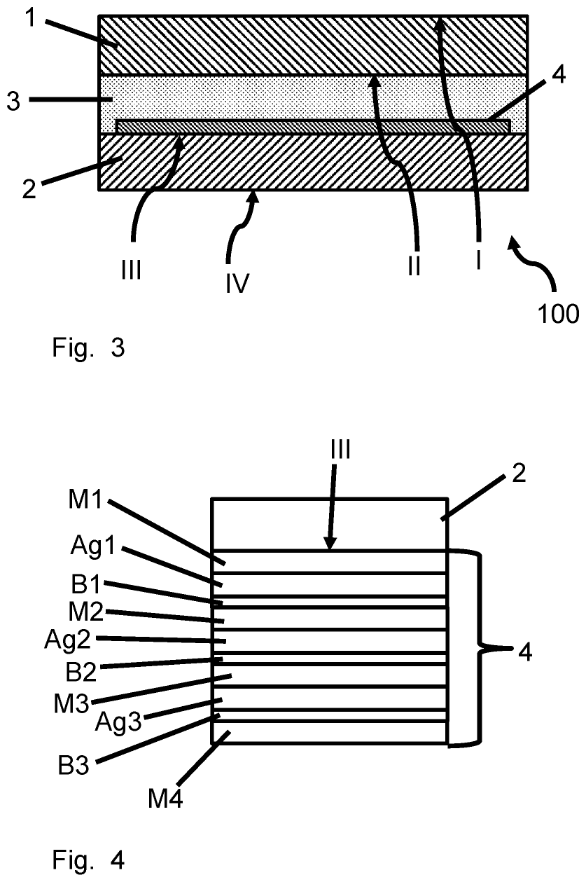

FIG. 3 a cross-section through another embodiment of the composite pane according to the invention having a sun shading coating,

FIG. 4 a schematic representation of the structure of a sun shading coating according to the invention applied on the inner pane of the composite pane, and

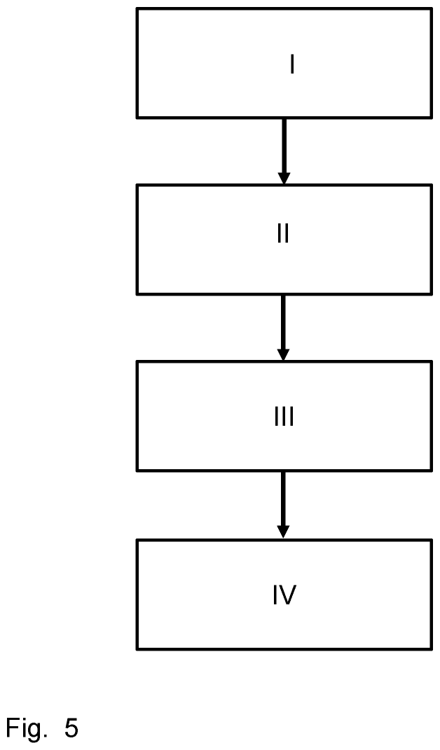

FIG. 5 a flow chart of an embodiment of the method according to the invention.

FIG. 1 depicts a cross-section through an embodiment of the composite pane 100 according to the invention having a sun shading coating 4. The composite pane 100 comprises an outer pane 1 and an inner pane 2 joined to one another via a thermoplastic intermediate layer 3. The composite pane 100 can, for example, be provided as a windshield of a passenger car, with the outer pane 1 facing the external surroundings and the inner pane 2 facing the vehicle interior. The outer pane 1 has an outer surface (I) and an inner surface (II). The inner pane 2 has an outer surface (III) and an inner surface (IV). The outer surfaces (I) and (III) face the external surroundings; the inner surfaces (II) and (IV) face the vehicle interior. The inner surface (II) of the outer pane 1 and the outer surface (III) of the inner pane 2 face one another. In this embodiment, a sun shading coating 4 according to the invention is arranged on the inner surface (II) of the outer pane 1. The sun shading coating 4 extends over the entire inner surface (II), preferably minus a circumferential frame-shaped coating-free region, for example, with a width of 8 mm. The coating-free region can then be hermetically sealed by bonding to the thermoplastic intermediate layer 3. The sun shading coating 4 is thus advantageously protected against damage and corrosion. According to the invention, the sun shading coating 4 comprises at least three functional silver layers, each of which has a geometrical layer thickness between 5 nm and 20 nm, with each functional silver layer being arranged between dielectric modules, for example, layers of silicon nitride. The silver layers (Ag1, Ag2, Ag3) of the sun shading coating according to the invention have a layer thickness relative to one another of 1.0<Ag1/Ag3 and 1.2<Ag2/Ag3<2, where Ag2>Ag1>Ag3. The dielectric modules (M1, M2, M3, M4) have an optical layer thickness relative to one another of M2/M1≥1.9, M2/M3≥0.8, and M2/M4≥2. The structure of the sun shading coating 4 according to the invention is described in more detail below with FIG. 4 and the examples and comparative examples explained there. The sun shading coating 4 results in reduced heating of the vehicle interior and of the inner pane 2 due to the reflection of infrared radiation. Energy reflection RE>30%, total solar transmittance TTS<45%, and light transmittance TL>72.5% can be achieved. Also, with the sun shading coating 4 according to the invention, good optical and aesthetic properties of the composite pane 100 are achieved in addition to improved thermal comfort, at the same time. The sheet resistance of the sun shading coating 4 is between 1.0 Ω/sq and 1.5 Ω/sq, as a result of which the coating has good compatibility with 14V/42V DC/DC converters.

FIG. 2 depicts a cross-section through another embodiment of the composite pane 100 according to the invention having a sun shading coating 4. In contrast to FIG. 1, the sun shading coating 4 is arranged not on the inner surface (II) of the outer pane 1, but on a carrier film 5 in the intermediate layer 3. The carrier film 5 preferably contains or is made of polyethylene terephthalate (PET) and has, for example, a thickness of 50 μm. The sun shading layer 4 according to the invention comprises a layer structure, which is explained in greater detail with regard to FIG. 4. The carrier film 5 with the sun shading coating 4 is arranged between a first thermoplastic film 3a and a second thermoplastic film 3b. In the resulting composite pane, the thermoplastic films 3a and 3b and the carrier film 5 form the thermoplastic intermediate layer 3. The thermoplastic films 3a and 3b preferably contain or are made of PVB and have, for example, a layer thickness of 0.38 mm. The carrier film 5 is somewhat smaller than the outer pane 1, the inner pane 2, and the thermoplastic films 3a and 3b. The carrier film 6 is arranged in the composite such that the carrier film 5 does not extend all the way to the lateral edges of the composite glass. As a result, the carrier film 5 is surrounded in the edge region of the composite pane for example, circumferentially by the thermoplastic films 3a and 3b, with a width of approx. 8 mm. The sun shading coating 4 on the carrier film 5 is thus advantageously protected against damage and, in particular, corrosion.

FIG. 3 depicts a cross-section through another embodiment of the composite pane 100 according to the invention having a sun shading coating 4. In contrast to FIG. 1, the sun shading coating 4 is arranged not on the inner surface (II) of the outer pane 1, but on the outer surface (III) of the inner pane 2, with a circumferential edge region of the outer surface (III) not provided with the sun shading coating 4. In this embodiment as well, the sun shading coating 4 is advantageously protected against damage and corrosion. For the rest, this embodiment corresponds to the design depicted in FIG. 1.

FIG. 4 depicts a schematic structure of a sun shading coating 4 according to the invention. In the embodiment depicted, the sun shading coating 4 is applied on the inner side III of the inner pane 2 as a substrate. The sun shading coating 4 depicted contains three transparente functional silver layers Ag1, Ag2, and Ag3, which are in particular the infrared-radiation-reflecting layers. The functional silver layers have a certain thickness relative to one another; specifically, provision is made for the following to be true for the relative geometrical layer thicknesses Ag2>Ag1>Ag3, 1.0<Ag1/Ag3 and 1.2<Ag2/Ag3<2. In other words, the layer thickness of the third silver layer Ag3, which is arranged closest to the outer pane 1 is thinner than the layer thickness of the first silver layer Ag1, closest to the inner pane 2, while the second silver layer Ag2, which is positioned between the first silver layer Ag1 and the third silver layer Ag3 in the layer sequence, is the silver layer with the greatest layer thickness. The silver layers can be deposited, for example, by cathodic sputtering in an argon atmosphere.

Dielectric modules M1, M2, M3, and M4 including dielectric layers are in each case arranged above, below, and between the silver layers Ag1, Ag2, and Ag3. These dielectric modules (M1, M2, M3, M4) preferably have, relative to one another, an optical layer thickness M2/M1≥1.9, M2/M3≥0.8, and M2/M4≥2. The dielectric module M1 is thus arranged below the first silver layer Ag1 directly on the inner side III of the inner pane 2; the second dielectric module M2 is arranged above the first silver layer Ag1. The first dielectric module M1 can, for example, be structured, starting from the inner pane 2, as a layer sequence of silicon nitride, ZnSnOx, and ZnO layers. The silicon nitride layer can be deposited from silicon nitride in a nitrogen-containing atmosphere; the zinc oxide layer, from zinc oxide in an oxygen-containing atmosphere.

The sun shading coating 4 contains at least one blocking layer; particularly preferably each functional silver layer Ag1, Ag2, Ag3 is situated, as depicted, in direct contact with at least one blocking layer B1, B2, and B3. According to the invention, the blocking layers preferably contain or are made of at least nickel, chromium, or alloys thereof and/or titanium chromium. The blocking layers B (B1, B2, B3) are preferably arranged between at least one functional silver layer and at least one dielectric layer. The blocking layers B protect the functional layer during heating, in particular during production of the composite pane according to the invention.

The invention is explained with reference to the following Examples according to the invention and Comparative Examples not according to the invention.

### EXAMPLES

All optical, aesthetic, and energy properties of the composite panes according to the Examples and the Comparative Examples were measured in the laminated state. In the Examples and the Comparative Examples, the sun shading coating 4 was applied to the outer side III of a clear inner pane 2 (Example Planiclear) in accordance with FIG. 4 and laminated with a thermoplastic intermediate layer 3 and an outer pane 1 in accordance with the structure of FIG. 3. A non-tinted PVB film was used in the intermediate layer.

The Examples and Comparative Examples have the same basic structure described, but differ in the sun shading coatings used.

Examples 1 through 5 according to the invention and Comparative Examples 1 through 3 not according to the invention were produced as a composite pane (windshield for a vehicle) with the sun shading coatings indicated.

For each Example and Comparative Example, the stack structure of the sun shading coating (layers and layer thicknesses) and the optical properties of the coating in the finished composite pane are indicated.

The layer sequences and layer thicknesses of the sun shading coatings in accordance with Examples 1 to 5 according to the invention as well as the Comparative Examples 1 to 3, shown in comparison thereto, are presented in Table 1. The relativen layer thicknesses of the silver layers and of the dielectric modules, as well as the values of the optical, electrical, and energy properties for the Examples 1 to 5 according to the invention and for the Comparative Examples 1 to 3 not according to the invention are reported in Table 2. All layer thicknesses of the silver layers and of the layers of the modules are indicated as geometrical layer thicknesses. The relative layer thicknesses of the silver layers, indicated as thickness ratios Ag2/Ag1, Ag2/Ag3, and Ag1/Ag3 refer to the geometrical layer thicknesses. For the relative layer thicknesses of the dielectric modules, indicated as thickness ratios M2/M1, M2/M3, and M2/M4, the optical thicknesses were used.

### Abbreviations

RE energy reflection [%]
TL visible light transmittance [%]
TTS total transmitted thermal radiation [%]
TE total transmitted energy [%]
RL 8° visible reflection at a viewing angle of 8° [%]
RL 60° visible reflection at a viewing angle of 60° [%]
a*, b* color coordinates in the CIE color space (International Commission on Illumination), measured in each case in reflection at an angle of 60° and at an angle of 8°
Δa*, Δb* difference in the color coordinates when measured in reflection at 60° and at 8°
Color R* color impression of the external reflection color in each case in reflection at 60° and at 8° perceived by the viewer of the composite pane
Rsq sheet resistance of the sun shading coating [Ω/sq]

The values for light transmittance (TL) and reflection (RL) are based on illuminant A, which by definition is based on the relative radiation distribution of the Planckian radiator with 2856 Kelvin.

TABLE 1
Layer Structures of the Sun Shading Coating per Examples
1 to 5 and Comparative Examples 1 to 3

| | | | | | | | Layer | | |
|---|---|---|---|---|---|---|---|---|---|
| | | Layer Thicknesses [nm] per | | | | | Thicknesses [nm] | | |
| Layer | | Example According to the | | | | | per Comparative | | |
| se- | Layer | Invention | | | | | Example | | |
| quence | material | #1 | #2 | #3 | #4 | #5 | #1 | #2 | #3 |
| Outer | Glass | | | | | | | | |
| pane 1 | | | | | | | | | |
| M1 | SiZrNₓ | 13.2 | 12.5 | 13.9 | 12.8 | 15.5 | 11.9 | 13.4 | 13.0 |
| | ZnSnOₓ | 8.0 | 8.0 | 8.0 | 8.0 | 8.0 | 8.0 | 8.0 | 8.0 |
| | ZnO | 11.0 | 12.0 | 11.0 | 12.0 | 11.0 | 11.0 | 11.0 | 12.0 |
| Ag1 | Ag | 10.3 | 9.4 | 10.7 | 10.0 | 9.6 | 10.0 | 10.5 | 10.0 |
| B1 | NiCr | 0.4 | 0.4 | 0.4 | 0.5 | 0.4 | 0.5 | 0.4 | 0.5 |
| M2 | ZnO | 11.0 | 12.0 | 11.0 | 12.0 | 11.0 | 11.0 | 11.0 | 12.0 |
| | SiZrNₓ | 11.1 | 11.0 | 11.1 | 10.7 | 13.9 | 11.3 | 11.1 | 10.8 |
| | Si₃N₄ | 18.8 | 19.3 | 18.8 | 18.5 | 19.4 | 18.9 | 18.8 | 18.6 |
| | SiZrNₓ | 8.5 | 8.6 | 8.5 | 8.4 | 8.5 | 8.6 | 8.5 | 8.4 |
| | ZnSnOₓ | 8.0 | 8.0 | 8.0 | 8.0 | 8.0 | 8.0 | 8.0 | 8.0 |
| | ZnO | 11.0 | 12.0 | 11.0 | 12.0 | 11.0 | 11.0 | 11.0 | 12.0 |
| Ag2 | Ag | 13.1 | 12.1 | 13.5 | 13.0 | 13.0 | 11.0 | 13.5 | 13.1 |
| B2 | NiCr | 0.0 | 0.0 | 0.0 | 0.0 | 0.0 | 0.2 | 0.0 | 0.0 |
| M3 | ZnO | 11.0 | 12.0 | 11.0 | 12.0 | 11.0 | 11.0 | 11.0 | 12.0 |
| | Sl₃N₄ | 39.9 | 39.1 | 40.4 | 39.4 | 41.4 | 40.2 | 40.3 | 39.2 |
| | SiZrNₓ | 8.4 | 7.8 | 8.4 | 8.4 | 9.5 | 8.5 | 8.4 | 8.3 |
| | ZnSnOₓ | 8.0 | 8.0 | 8.0 | 8.0 | 8.0 | 8.0 | 8.0 | 8.0 |
| | ZnO | 11.0 | 12.0 | 11.0 | 12.0 | 11.0 | 11.0 | 11.0 | 12.0 |
| Ag3 | Ag | 9.5 | 9.0 | 10.2 | 9.5 | 9.3 | 10.4 | 12.5 | 12.8 |
| B3 | NiCr | 0.2 | 0.0 | 0.2 | 0.2 | 0.2 | 0.3 | 0.2 | 0.2 |
| M4 | Zno | 11.0 | 12.0 | 11.0 | 12.0 | 11.0 | 11.0 | 11.0 | 12.0 |
| | SiZrN₄ | 7.4 | 8.1 | 7.4 | 7.6 | 9.7 | 7.3 | 7.4 | 7.6 |
| | Si₃N₄ | 7.5 | 8.0 | 7.4 | 7.6 | 8.9 | 7.4 | 7.5 | 7.6 |

TABLE 2
Thickness ratios and Optical Properties in the Laminate per
Examples 1 to 5 and Comparative Examples 1 to 3

| | | | | | Thickness Ratios and | | |
|---|---|---|---|---|---|---|---|
| | | | | | Optical Properties | | |
| Thickness Ratios and Optical | | | | | per Comparative | | |
| Properties per Example | | | | | Example | | |
| #1 | #2 | #3 | #4 | #5 | #1 | #2 | #3 |

Thickness Ratios

| | | | | | | | | |
|---|---|---|---|---|---|---|---|---|
| Ag2/Ag1 | 1.28 | 1.29 | 1.26 | 1.30 | 1.35 | 1.10 | 1.29 | 1.31 |
| Ag2/Ag3 | 1.38 | 1.34 | 1.33 | 1.37 | 1.40 | 1.06 | 1.08 | 1.03 |
| Ag1/Ag3 | 1.08 | 1.04 | 1.06 | 1.05 | 1.03 | 0.96 | 0.84 | 0.78 |
| M2/M1 | 2.08 | 2.14 | 2.04 | 2.08 | 2.19 | 2.19 | 2.07 | 2.07 |
| M2/M3 | 0.90 | 0.92 | 0.89 | 0.90 | 0.90 | 0.90 | 0.89 | 0.90 |
| M2/M4 | 2.65 | 2.52 | 2.65 | 2.56 | 2.68 | 2.68 | 2.65 | 2.57 |

Optical Properties

| | | | | | | | | |
|---|---|---|---|---|---|---|---|---|
| TL | 72.8 | 75.4 | 72.5 | 72.7 | 74.1 | 72.5 | 72.5 | 72.4 |
| RL 8° | 10.0 | 9.0 | 10.1 | 10.0 | 10.1 | 9.2 | 9.5 | 9.3 |
| a*R 8° | −1.0 | −1.0 | −1.0 | −1.0 | −1.0 | 1.2 | −2.6 | −1.9 |
| b*R 8° | −9.0 | −9.0 | −9.0 | −9.0 | −9.0 | −7.0 | −11.1 | −10.7 |
| a*R 60° | 0.0 | −0.4 | 0.0 | −0.5 | −0.9 | −2.3 | 1.2 | 0.8 |
| b*R 60° | −5.0 | −4.7 | −4.6 | −5.0 | −5.0 | −2.4 | −5.4 | −4.9 |
| Color | blue | blue | blue | blue | blue | violet | blue | blue |
| R*8° | | | | | | | | |
| Color | blue | blue | blue | blue | blue | blue- | violet | violet |
| R*60° | | | | | | green | | |
| Δ a*R | 1.0 | 0.6 | 1.0 | 0.5 | −3.5 | −3.5 | 3.8 | 2.7 |
| (8° vs. | | | | | | | | |
| 60°) | | | | | | | | |
| Δ b*R | 4.0 | 4.3 | 4.4 | 4.0 | 4.6 | 4.6 | 5.7 | 5.8 |
| (8° vs. | | | | | | | | |
| 60°) | | | | | | | | |
| RE | 35.8 | 33.5 | 37.0 | 35.2 | 34.1 | 33.5 | 38.9 | 38.2 |
| TE | 36.1 | 39.3 | 35.2 | 36.6 | 38.1 | 37.7 | 34.0 | 34.5 |
| TTS | 41.8 | 44.9 | 40.8 | 42.3 | 43.8 | 43.5 | 39.5 | 40.1 |
| Rsq | 1.26 | 1.41 | 1.18 | 1.28 | 1.31 | 1.35 | 1.09 | 1.12 |

According to the invention, composite panes having a sun shading coating structured according to the invention are provided which were successfully improved in terms of energy and electrical properties, thermal and visual comfort, and at the same time in terms of aesthetic appearance and were further optimized compared to known composite panes having sun shading coatings. Total transmitted thermal radiation (TTS) of less than 45% was achieved such that the corresponding frequently requested customer specification can be met. In addition, light transmittance TL≥72.5% was achieved such that the composite pane can be used as a windshield; and also when combined with common wire heaters, the legal requirement TL≥70% is achieved. In addition, optimum aesthetic appearance without undesirable color tones in the reflection of the composite pane is achieved. In particular, undesirable red, yellow, violet, and green reflections or hazing of the composite pane can be avoided. A substantially constant, desirable color reflection of the composite pane can be achieved regardless of the viewing angle. Furthermore, the sun shading coatings according to the invention have sheet resistance between 1.0 Ω/sq and 1.5 Ω/sq and are thus well suited for heating with a supply voltage of 42 V.

To further illustrate the advantages of the thickness combination of the silver layers, exemplary optical and energy properties of silver coatings with the respective thickness ratios indicated are reported in Table 3. The thickness of the dielectric modules and the order of the layers in the layer stack are identical in each case.

TABLE 3
Overview of the optical properties TL, TTS, RL 60°, and
the external reflection color at 60° for the various
possible thickness ratios of the silver layers Ag1, Ag2, and Ag3.

| Permutations Ag | TL | TTS | RL 60° | a*R 60° | b*R 60° |
|---|---|---|---|---|---|
| Ag1 > Ag2 > Ag3 | 73.1 | 43.4 | 17.9 | −8.0 | −1.5 |
| Ag1 > Ag3 > Ag2 | 69.3 | 43.3 | 21.3 | −13.6 | 5.7 |
| Ag2 > Ag1 > Ag3 | 74.6 | 42.9 | 17.1 | −1.0 | −3.5 |
| Ag2 > Ag3 > Ag1 | 72.7 | 42.4 | 19.6 | −0.2 | 3.6 |
| Ag3 > Ag1 > Ag2 | 67.6 | 42.7 | 23.9 | −11.8 | 11.8 |
| Ag3 > Ag2 > Ag1 | 69.5 | 42.3 | 23.0 | −5.5 | 11.8 |
| Ag1 = Ag2 = Ag3 (10.7 nm) | 72.0 | 43.2 | 19.6 | −7.7 | 4.4 |

As can be seen in Table 3, good optical and energy properties as well as appealing coloration can be achieved only with the thickness ratios of the silver layers according to the invention, with the following stipulation for the thickness of the silver layers: Ag2>Ag1>Ag3. Layers with the following properties are considered acceptable: TL≥72.5%, TTS≤45%, RL 60°≤17.5%. In addition, the color coordinates should be the smallest possible and particularly preferably have a negative sign. It can be seen from Table 2 that only for the thickness combination according to the invention with Ag2>Ag1>Ag3, 1.0>Ag1/Ag3 and 1.2<Ag2/Ag3<2 both at a viewing angle of 8° and at a viewing angle of 60°, the desired blue reflection color is achieved. In this color range, blue tones, which have a particularly high level of customer acceptance, are obtained.

Values for a*R 60° between −5.0 and 0 and for b*R 60° also between −8.0 and 0 are particularly advantageous.

FIG. 5 depicts an exemplary embodiment of the method according to the invention referencing a flow chart comprising the following steps.
I Providing an outer pane 1, an inner pane 2, and at least one thermoplastic film to form the thermoplastic intermediate layer 3;
II Applying a sun shading coating 4 according to the invention to the inner surface II of the outer pane 1 or to the outer surface III of the inner pane 2, for example, by means of cathodic sputtering;
III Optionally: Applying bus bars on the sun shading coating 4;
IV Joining the inner surface II of the outer pane 1 and the outer surface III of the inner pane 2 via the thermoplastic intermediate layer 3 to form a composite pane 100.

In one embodiment, glass panes are used as the outer pane 1 and as the inner pane 2. In a preferred embodiment of the method, the sun shading coating 4 having the at least three functional silver layers Ag1, Ag 2, and Ag3 and the at least four dielectric modules M1, M2, M3 and M4 is applied on the outer surface III of the inner pane 2, preferably by means of magnetron-enhanced cathodic sputtering. If heating of the pane via the sun shading coating 4 is provided, bus bars are provided on the sun shading coating 4 prior to lamination of the pane as well as electrical connection cables that enable electrical contacting of the coating. The joining of the outer pane 1 and the inner pane 2 via the intermediate layer 3 to form the composite glass is preferably done after the sun shading coating 4 has been applied.

### LIST OF REFERENCE CHARACTERS

1 outer pane
2 inner pane
3 thermoplastic intermediate layer
3a first thermoplastic film
3b second thermoplastic film
4 sun shading coating
5 carrier film
I outer surface of 1
II inner surface of 1
III outer surface of 2
IV inner surface of 2
Ag1 first silver layer
Ag2 second silver layer
Ag3 third silver layer
M1 first dielectric module
M2 second dielectric module
M3 third dielectric module
M4 fourth dielectric module
B blocking layer
B1 first blocking layer
B2 second blocking layer
B3 third blocking layer

1. A composite pane, comprising an outer pane having an exterior-side surface and an interior-side surface, an inner pane having an exterior-side surface and an interior-side surface, and a thermoplastic intermediate layer, which joins the interior-side surface of the outer pane to the exterior-side surface of the inner pane, wherein the composite pane has at least one sun shading coating between the outer pane and the inner pane, wherein
the sun shading coating comprises, starting from the inner pane toward the outer pane, a layer sequence
first dielectric module,
first silver layer,
second dielectric module,
second silver layer,
third dielectric module,
third silver layer,
fourth dielectric module,
wherein the first, second and third silver layers have, relative to one another, a geometrical layer thickness of Ag2>Ag1>Ag3, where Ag1 is the geometrical layer thickness of the first silver layer, Ag2 is the geometrical layer thickness of the second silver layer, and Ag3 is the geometrical layer thickness of the third silver layer, and the first, second and third silver layers of the sun shading coating have a relative geometrical layer thickness of 1.0<Ag1/Ag3 and 1.2<Ag2/Ag3<2.

2. The composite pane according to claim 1, wherein the first, second, third and fourth dielectric modules have a relative optical layer thickness of M2/M1≥1.9, M2/M3≥0.8, and M2/M4≥2, where M1 is the optical layer thickness of the first dielectric module, M2 is the optical layer thickness of the second dielectric module, M3 is the optical layer thickness of the third dielectric module and M4 is the optical layer thickness of the fourth dielectric module.

3. The composite pane according to claim 1, wherein the first dielectric module, the second dielectric module, the third dielectric module, and/or the fourth dielectric module have at least one dielectric layer based on silicon nitride.

4. The composite pane according to claim 1, wherein the first dielectric module, the second dielectric module, the third dielectric module, and/or the fourth dielectric module include at least one first dielectric layer based on silicon nitride and at least one second dielectric layer based on zinc oxide.

5. The composite pane according to claim 1, wherein the first dielectric module, the second dielectric module, the third dielectric module, and/or the fourth dielectric module include at least one first dielectric layer based on silicon nitride, at least one second dielectric layer based on zinc oxide, and at least one third dielectric layer based on a mixed tin-zinc oxide.

6. The composite pane according to claim 1, wherein the sun shading coating includes, above and/or below the first, second and third silver layers, in each case at least one metallic blocking layer, which has a geometrical thickness of less than 1 nm.

7. The composite pane according to claim 1, wherein the first silver layer, the second silver layer, and the third silver layer have, in each case, a geometrical thickness of 5 nm to 25 nm.

8. The composite pane according to claim 7, wherein the first silver layer has a geometrical thickness of 7 nm to 14 nm, the second silver layer has a geometrical thickness of 7 nm to 16 nm, and the third silver layer has a geometrical thickness of 6 nm to 13 nm.

9. The composite pane according to claim 1, wherein the first dielectric module, the second dielectric module, the third dielectric module, and the fourth dielectric module have, in each case, a geometrical thickness of 10 nm to 100 nm.

10. The composite pane according to claim 1, wherein the sun shading coating is applied on the exterior-side surface of the inner pane.

11. The composite pane according to claim 1, wherein the sun shading coating has at least two bus bars via which the sun shading coating is connectable to an electrical voltage source.

12. The composite pane according to claim 1, wherein heating wires are present between the exterior-side surface of the inner pane and the interior-side surface of the outer pane.

13. The composite pane according to claim 1, wherein the sun shading coating contains exactly three silver layers.

14. A method for producing a composite pane according to claim 1 comprising:
a) applying a sun shading coating to the interior-side surface of the outer pane, or to the exterior-side surface of the inner pane, or introducing the sun shading coating into a thermoplastic intermediate layer,
b) producing a layer stack comprising at least, in this order, the outer pane, the thermoplastic intermediate layer, and the inner pane, and
c) joining the layer stack comprising at least the outer pane, the thermoplastic intermediate layer, and the inner pane to form the composite pane.

15. A method comprising providing a composite pane according to claim 1 in a motor vehicle-preferably as a windshield, rear window, side window, and/or roof panel.

16. The composite pane according to claim 9, wherein the first dielectric module, the second dielectric module, the third dielectric module, and the fourth dielectric module have, in each case, a geometrical thickness of 20 nm to 90 nm.

17. The composite pane according to claim 16, wherein the first dielectric module, the second dielectric module, the third dielectric module, and the fourth dielectric module have, in each case, a geometrical thickness of 70 nm to 85 nm.

18. The method according to claim 15, wherein the composite pane is a windshield of a motor vehicle.
